(19) United States
(12) Patent Application Publication
(10) Pub. No.: US 2025/0043631 A1
(43) Pub. Date: Feb. 6, 2025

(54) A DAMPING DEVICE AND AN ASYMMETRIC DAMPING BLOCK ADAPTED TO BE ARRANGED IN A DAMPING DEVICE FOR A COLLAPSIBLE LADDER, A COLLAPSIBLE LADDER AND A METHOD FOR ARRANGING A DAMPING DEVICE IN A COLLAPSIBLE LADDER

(71) Applicant: Telesteps AB, Tranås (SE)

(72) Inventor: Rikard MATTSSON, Aneby (SE)

(73) Assignee: Telesteps AB, Tranås (SE)

(21) Appl. No.: 18/714,979

(22) PCT Filed: Jul. 15, 2022
(86) PCT No.: PCT/SE2022/050720

§ 371 Date: May 30, 2024

(30) Foreign Application Priority Data
Dec. 2, 2021 (SE) 2151472-4

(51) Int. Cl. E06C 1/12; F16F 7/08

(52) U.S. Cl. CPC E06C 1/125; F16F 7/08; F16F 2230/0041

(57) ABSTRACT

A damping device (120; 220; 320; 420) for a collapsible ladder (1) is provided. The collapsible ladder is comprising an inner ladder tube section (40a) and an outer ladder tube section (40b) having an inner side wall (44b), the inner ladder tube section (40a) being slidably arranged with the outer ladder tube section (40b). The damping device (120; 220; 320; 420) is comprising a main body (121) having a top portion adapted to be arranged at least partly in the inner ladder tube section (40a), and at least one mounting means (122; 422), and an asymmetric damping block (140; 550; 550′; 550″) adapted to be arranged in the mounting means (122; 422), wherein the asymmetric damping block (140; 550; 5501; 550″) comprises at least one surface (142) slidably abutting the inner side wall (44b) of the outer ladder tube section (40b) when arranged in the collapsible ladder.

### TECHNICAL FIELD

The present invention generally relates to collapsible ladders. More specifically, the present invention relates to a damping device for use in a collapsible ladder.

### BACKGROUND

As is well known by persons skilled in the art of collapsible ladders, such ladders usually comprise a number of tube portions having various diameters being telescopically insertable into one another. Every upper end of any of the tube portions are fastened to one end of a ladder step, or rung, whereas the other end of the ladder step is fastened to an upper end of a tube portion having the same diameter. The two tube portions and the ladder step form a ladder section, the tube sections of which being insertable into an adjacent ladder section comprising tube portions having a larger diameter.

The resulting ladder may be collapsed accordingly by inserting higher ladder sections into lower ladder sections. The ladder can correspondingly be extended by extending higher ladder sections from the lower ladder sections. A pin extending through the holes in the outer walls of two adjacent tube portions may lock the tube portions to prevent the extended ladder from collapsing. Ladders having collapsible and expandable ladder sections are used in order to make the ladder smaller such that the ladder can, for instance, be stored and/or transported with more ease.

It is generally beneficial if the ladder tubes descend and fold rapidly in order to achieve an easier managing of the ladder. However, if the descent is too fast, there is a risk that fingers, or other body parts, of the user can be clamped or crushed if the user is inappropriately positioned with respect to the ladder. In other ladders that are used for e.g. reaching an attic of a house, the gravity and weight of the ladder may cause the ladder to extend rapidly and thus damage the floor, or injure the user, upon the extension thereof. Prior art solutions have consequently applied damping solutions to provide safety for users and the surroundings upon managing collapsible ladders.

However, the prior art damping solutions are limiting in several aspects. Disadvantages of current solutions include, for instance, poor adaptability to different types of collapsible ladders, difficulty in adjusting the damping effect of the collapsible ladder, complex and/or expensive constructions, ungainly solutions, to name a few. It is thus an object of the present invention to provide an improved damping device for a collapsible ladder.

### SUMMARY

An object of the present invention is therefore to provide a damping device, asymmetric damping block, collapsible ladder and a method for arranging a collapsible ladder, which solve, or at least a mitigate, one or more of the problems or drawbacks identified in the background section above.

In a first aspect, a damping device for a collapsible ladder is provided. The collapsible ladder comprises an inner ladder tube section and an outer ladder tube section having an inner side wall, the inner ladder tube section being slidably arranged with the outer ladder tube section, the damping device comprising: a main body having a top portion adapted to be at least partly arranged in the inner ladder tube section, and at least one mounting means, and an asymmetric damping block adapted to be arranged in the at least one mounting means, wherein the asymmetric damping block comprises at least one surface slidably abutting the inner side wall of the outer ladder tube section when mounted in the collapsible ladder.

The damping device provides several benefits. The mounting means allows the damping blocks to be arranged therein without the need of further components, such as different kinds of fastening means. This is time efficient and saves material, which in turn saves costs and the environmental impact.

Moreover, the damping block can be used for different kinds of ladder tubes as it shape is not dependent on the shape and/or dimensions of the ladder tubes. This provides a robust solution which is less sensitive to different tolerances.

Yet further, once the damping block has been arranged inside the damping device, and the damping device is arranged in the ladder tube it is not for the damping blocks to fall out, or in other way be accidentally removed.

In one or more embodiments, the asymmetric damping block being arranged in the receiving portion is asymmetric with respect to a center axis extending horizontally from a center point of the inside of the ladder tube sections towards the outside of the ladder tube sections.

In one or more embodiments, the asymmetric damping block is arranged to cause one of at least two different damping behaviours for the ladder tube sections.

In one or more embodiments, an orientation, position and/or size of the asymmetric damping block arranged in the mounting means, relative the inner side wall, causes said one of at least two different damping behaviours.

In one or more embodiments, each damping behaviour comprises a first effect and a second effect, wherein the first and second effect are different from each other.

In one or more embodiments, a first orientation, position and/or size of the asymmetric damping block causes a first damping behaviour for the ladder tube sections, and a second orientation, position and/or size of the asymmetric damping block causes a second damping behaviour for the ladder tube sections.

In one or more embodiments, in the first damping behaviour, inwards retraction of the inner ladder tube section with respect to the outer ladder tube section causes a second effect, wherein the second effect forces the asymmetric damping block to move causing a damping effect on the ladder tube sections, and outwards extension of the inner ladder tube section with respect to the outer ladder tube section causes a first effect, wherein the first effect releases the damping effect caused by the asymmetric damping block.

In one or more embodiments, in the second damping behaviour, inwards retraction of the inner ladder tube section with respect to the outer ladder tube section causes a first effect, wherein the first effect releases the damping effect caused by the asymmetric damping block, and outwards extension of the inner ladder tube section with respect to the outer ladder tube section causes a second effect, wherein the second effect forces the asymmetric damping block to move causing a damping effect on the ladder tube sections.

In one embodiment, the first damping behaviour comprises a damping effect caused in a downward direction and the second damping behaviour comprises a damping effect caused in an upward direction.

In one or more embodiments, the at least one mounting means comprises a cavity, or slot, facing the inner side wall, wherein the asymmetric damping block is adapted to at least party fit within the cavity.

In one or more embodiments, the damping device comprises two mounting means each having a cavity and two damping blocks wherein the respective cavity is facing different circumferential positions about the inner side wall, and wherein the asymmetric damping blocks each are adapted to fit at least partly within each respective cavity.

In one or more embodiments, the asymmetric damping block is adapted to fit within the cavity by means of clamping.

In one or more embodiments, the asymmetric damping block is a single integrated pre-molded block.

In one or more embodiments, the asymmetric damping block consists of a flexible homogeneous material.

In one or more embodiments, the damping device is arranged at least party on the inside of the inner ladder tube section.

In a second aspect, a collapsible ladder is provided. The collapsible ladder comprises a plurality of ladder sections, each ladder section comprising two ladder tubes arranged parallel to each other and interconnected by a rung to form the respective ladder section, wherein each ladder tube is telescopically inserted into a ladder tube of a lower section to form the collapsible ladder. Each ladder section comprises a damping device according to the first aspect or any of the embodiments depending thereon.

In a third aspect, an asymmetric damping block adapted to be arranged in a damping device for a collapsible ladder is provided. The collapsible ladder comprises an inner ladder tube section and an outer ladder tube section having an inner side wall, the inner ladder tube section being slidably arranged with the outer ladder tube section, the damping device comprising at least one mounting means. The asymmetric damping block is adapted to be arranged in the at least one mounting means, wherein the asymmetric damping block comprises at least one surface slidably abutting the inner side wall for causing one of at least two different damping behaviours for the ladder tube sections.

In a fourth aspect, a method for arranging a damping device in a collapsible ladder is provided. The method comprises: arranging a damping device to a first ladder tube section, the damping device comprising at least one mounting means; arranging at least one asymmetric damping block in the mounting means; and slidably inserting the first ladder tube section into a second ladder tube section such that at least one surface of the asymmetric damping block is slidably abutting an inner side wall of the second ladder tube section for forming a first part of a ladder section.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a-b show front views of an extended ladder (FIG. 1a) and of a maximally collapsed ladder (FIG. 1b) according to an embodiment.

FIG. 2 shows an isometric view of a rung according to an embodiment.

FIG. 3 a-h are schematic illustrations of a damping device for a collapsible ladder according to one embodiment.

FIGS. 4a-b are schematic illustrations of a damping device arranged in different orientations according to one embodiment.

FIGS. 5a-b are schematic illustrations of a damping device causing a first damping behaviour according to one embodiment.

FIGS. 6a-b are schematic illustrations of a damping device causing a second damping behaviour according to one embodiment.

FIGS. 7a-c are isometric views of asymmetric damping blocks according to different embodiments.

FIGS. 8a-c are isometric views of ladder tubes according to different embodiments;

FIGS. 9a-e are isometric and top views of an embodiment of the damping device.

FIGS. 10a-b are isometric views of a damping device according to one embodiment.

FIGS. 11-b are isometric views of a damping device according to one embodiment.

FIG. 12 is a schematic flowchart diagram illustrating a method of arranging a damper device in a collapsible ladder according to one embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

An object of the present invention is to provide a damping device for use in a ladder section of a collapsible ladder, which have an improved manufacturing process by reducing the complexity of the damping device and reducing the number of components. Accordingly, a more cost effective damping device is provided. More specifically, the novel damping device reduces the need for screws or similar attachment means. This provides both benefits in increasing the manufacturing process due to less processing steps, lowering of cost as well as environmental benefits. Additionally, the asymmetric properties of the damping blocks disclosed herein are particularly advantageous with respect to adaptability and universal applicability for different types of ladders associated with different damping requirements.

Another object of the present invention is to provide a damping device being applicable for any type of collapsible ladders. Depending on the orientation of asymmetric damping block(s) arranged in the damping device, the damping behaviour of the damping device can be adjusted. Hence, a desired damping effect can be achieved both upon extending and collapsing the collapsible ladder. The damping device is thus a multi-purpose damping device. For a collapsible ladder arranged for reaching, for instance, an attic of a house, it is desired that the ladder automatically extends upon opening e.g. a ceiling hatch. Using such ladders, it is desired that the damping effect be caused upon the extension thereof such that the ladder does not, for instance, slam onto the user's head or damage the floor or other objects in the house. For other collapsible ladders, it is desired that the damping effect instead be caused upon the collapsing thereof such that the user does not risk e.g. pinching his or her fingers.

Other objectives, features and advantages of the present invention will appear from the following detailed disclosure, from the attached claims, as well as from the drawings. It is noted that the invention relates to all possible combinations of features.

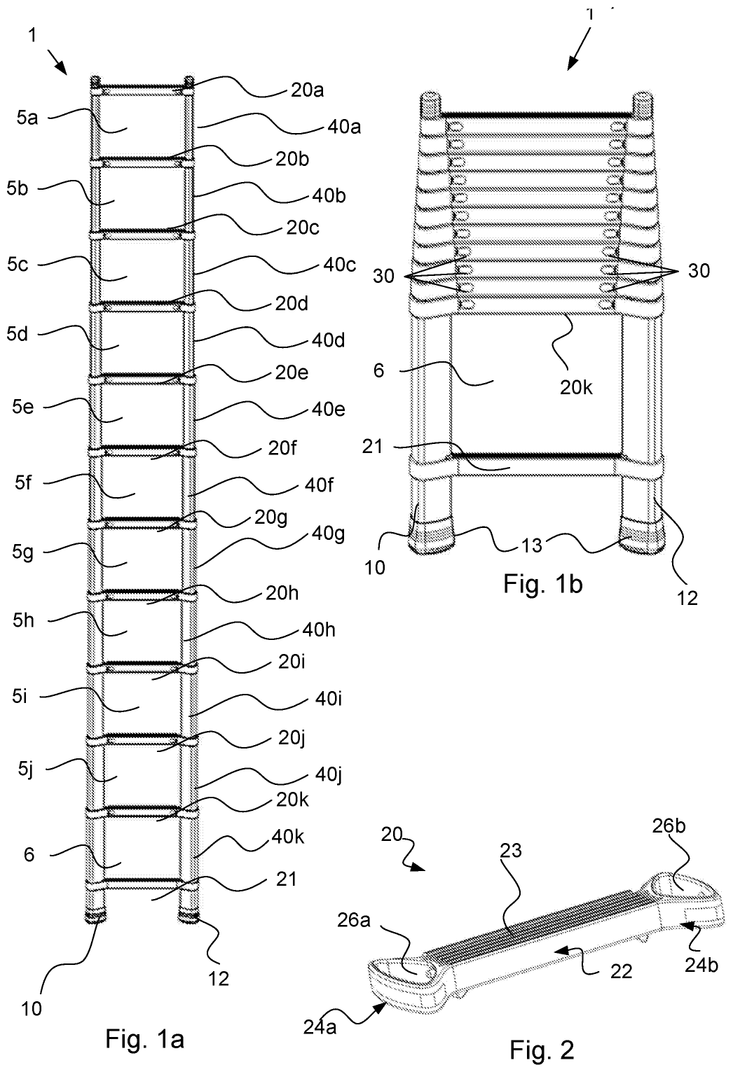

In FIG. 1a, a collapsible ladder 1 is shown in a fully extended state. The collapsible ladder 1 comprises several ladder sections 5a-j where each ladder section 5a-j comprises two ladder tubes 10, 12 and one rung 20a-k. The ladder sections 5a-j are in a U-shaped form where the two ladder tubes 10, 12 are arranged parallel to each other and are interconnected at one end by one rung 20a-k. The rungs 20a-k are arranged horizontally between the vertically arranged ladder tubes 10, 12, i.e. substantially perpendicular to the ladder tubes 10, 12. The ladder tubes 10, 12 are divided into ladder tube sections 40a-j, which telescope into each other. A ladder tube section 40a-j arranged higher than another ladder tube section 40a-j, for example section 40a being arranged higher than section 40b, has an outer diameter which is smaller than the inner diameter of the lower section 40b. This allows the higher section 40a to telescope inside the lower section 40b between an extended state and a collapsed, or retracted, state.

Each ladder tube section 40a-k can be constructed in different materials, for example be formed as an extruded aluminum profile. The suitable length of the ladder tube sections 40a-k may vary depending on national standards and the design of the ladder 1. The length of the ladder tube sections 40a-k may depend on the desired distance between the rungs 20a-k. The distance between the rungs 20a-k may be controlled by different standards, for example the recommended distance between rungs according to European standards is 250-300 mm.

A maximally collapsed ladder 1 is shown in FIG. 1b. In this state, the ladder 1 is easily transportable between locations, or alternatively appropriately stored. The lowermost ladder section 6 comprises a stationary rung 21, which is provided at the bottom of the ladder, designed to provide an extra foot support and a more stable lowermost ladder section 6. As seen in FIG. 1b, the lowermost ladder section 6 is stationary and cannot be telescoped into the other sections 5a-j. It is thus easier to carry the ladder 1. The lowermost ladder section 6 may comprise two rungs, the stationary rung 21 and the rung 20k.

The ladder tubes 10, 12 may be provided with end portions 13 on which the ladder stands. The end portions 13 are thus arranged at the lowest part of the ladder tubes 10, 12. The end portions 13 may be arranged with a material of high friction, thus lowering the risk of the ladder 1 moving during use.

In order to telescopically collapse and expand the ladder 1, a locking or retaining mechanism may be provided. In the embodiment shown in FIGS. 1a-b, a retaining mechanism comprises a plurality of actuators 30 arranged on each individual rung 20a-k in order to release the respective sections 5a-j. The retaining mechanism comprise a spring-loaded locking pin (not shown) which locks a ladder section 5a in relation to another adjacent ladder section 5b by being inserted into locking holes in the ladder tube 10, 12. Each section 5a-j is individually released by using the actuators 30 (such as rotary buttons or slide buttons) arranged on both sides of the rung 20a-k. By using the actuators 30, for example sliding slide buttons towards each other, the locking pins are withdrawn from the respective locking holes in the ladder tube 10, 12.

In one embodiment, the ladder 1 only comprises one pair of actuators 30. The one pair of actuators 30 may be arranged on the front side of the second lowermost rung 20k. The one pair of actuators 30 will still be able to collapse the entire ladder 1. Alternatively, the ladder 1 comprises a first pair of actuators 30 arranged on the second uppermost rung 20b and a second pair of actuators 30 arranged on a rung 20b-j positioned between the second uppermost rung 20b and the second lowermost rung 20k. The second pair of actuators 30 enables the lowering of a lower part of a collapsible ladder 1 and the first pair of actuators 30 enables the lowering of an upper part of the collapsible ladder 1. Such actuators 30 are described in the European patent EP1728966, which is hereby incorporated by reference.

In a further embodiment, the pin of the lowermost ladder section 6 may be withdrawn from interaction with its respective holes in the tubes of the neighbouring ladder section 5j by manipulating a foot control located and arranged to be maneuvered by a foot of a user using the ladder 1.

It should be noted that although only some types of locking/retaining mechanisms are mentioned herein, any type of mechanism suitable to collapse and expand a collapsible ladder could be used.

FIG. 2 shows an embodiment of a rung 20. The rung 20 comprises a main section 22, a first bracket section 24a and a second bracket section 24b. The first and second bracket sections 24a-b are arranged at each end of the rung 20 to receive the respective ladder tube 10, 12. Each bracket section 24a-b is arranged with an opening 26a-b having the same shape as the cross-sectional shape of the corresponding ladder tube 10, 12. The cross-sectional shape of the ladder tube 10, 12 may have a distinctive form. The cross-sectional shape of the openings 26a-b in FIG. 2 have a triangular shape. The shape of the openings 26a-b of the rung 20 shall correspond with the cross-sectional shape of the ladder tubes 10, 12.

In other embodiments, the shape of the openings 26a-b may differ if the ladder tubes 10, 12 have a different cross-sectional shape. For example, in one embodiment each opening 26a-b comprises in total six sections; a straight section and five additional sections being of convex shape.

The rung 20 may be provided as a single integrated unit, where the main section 22, the first bracket section 24a and the second bracket section 24b are one single piece. The main section 22 and the first and second bracket sections 24a-b may be formed by the same material. The material may be a thermoplastic material such as for example a polyamide (nylon). The material may be reinforced by adding compositions of glass fibres. In another embodiment, the first bracket section 24a and the second bracket sections 24b are provided as separate units attached to the main section 22 of the rung 20 for example by means of press fit.

Although not shown in FIGS. 1a-b, the ladder tubes 10, 12, and thus the ladder tube sections 40a-k, may comprise any number of mounting holes. The holes may for example be manufactured using punching, drilling, milling or electrical discharge machining. Each mounting hole corresponds to a rung protrusion arranged on each bracket section 24a, 24b of the rung 20, the cooperation between the mounting hole and the rung protrusions allows the rung 20 to be securely arranged on the ladder tube 10, 12. It should also be noted that the tubes 10, 12 may comprise more holes, for example fastening holes for devices preventing the ladder from being accidentally pulled apart or fastening holes for bracket sections used to connect a stabiliser system.

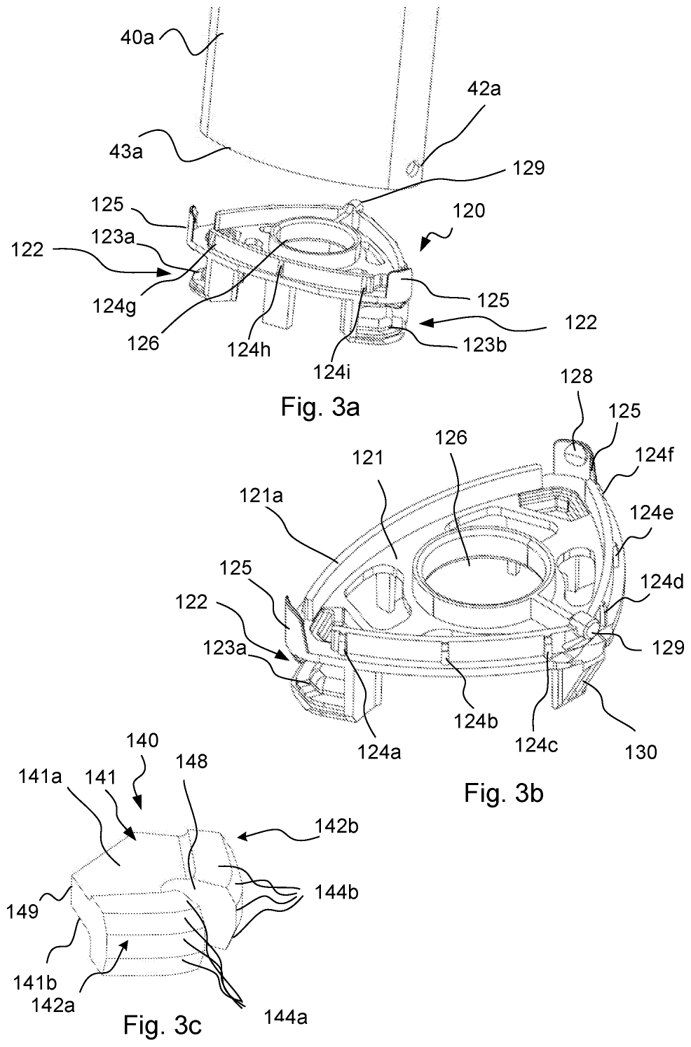

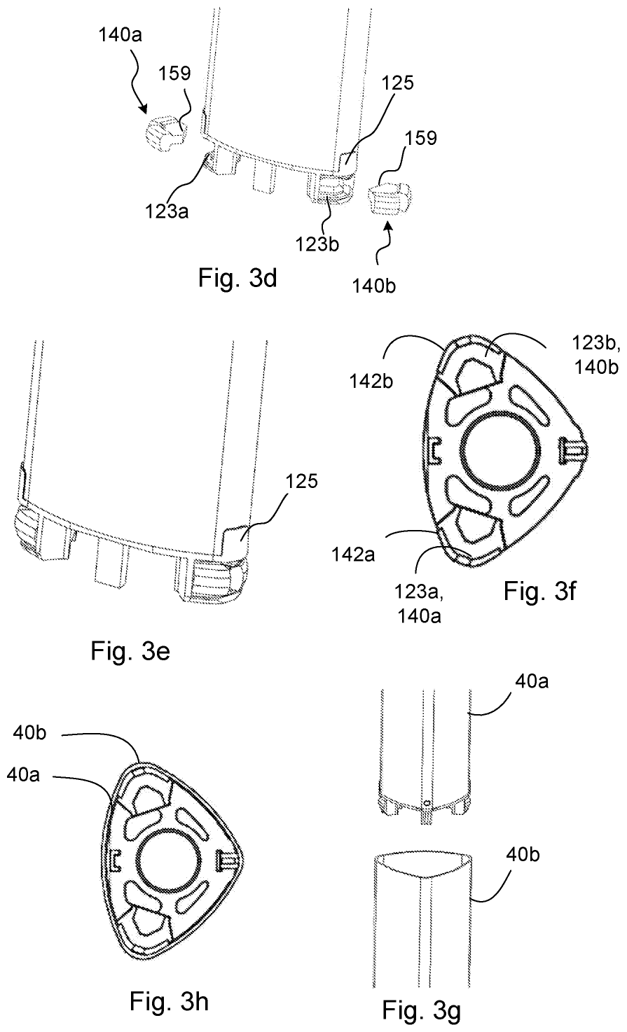

A damping device and how it is arranged in the ladder tube sections 40a-k will now be described in detail with reference to the different embodiments of FIGS. 3-12. For reasons of brevity, some general illustrative abstractions are taken into account. Although not explicitly visualized, the skilled person will appreciate that the embodiments defined herein are by no means to be construed as limiting to the scope of the present disclosure. For instance, damping devices may be arranged in any ladder tube section, provided that it is arranged in an inner ladder tube section with respect to a corresponding outer ladder tube section. Additionally, receiving means, mounting means, receiving portion, and asymmetric damping blocks are shown as comprising of two units each. The inventive concepts are, however, equally applicable for one or more of those units.

A first embodiment of a damping device 120 will now be described with reference to FIGS. 3-6. FIGS. 3a-h show isometric views of ladder tube sections 40a-b being arranged with a damping device 120. The damping device 120 is arranged generally in between the ladder tube sections 40a, 40b of the collapsible ladder 1, as shown in for example FIG. 3g. More specifically, the damping device 120 is arranged between an inner ladder tube section 40a and an outer ladder tube section 40b, wherein the inner ladder tube section 40a is slidably arranged (telescopically insertable) into the outer ladder tube section 40b. The inner ladder tube section 40a is arranged partly inside the outer ladder tube section 40b. For reasons of brevity, the examples of the damping device 120 being explained herein are mainly directed at a single damping device 120 arranged between the inner and outer ladder tube sections 40a-b. The skilled person will, however, appreciate that the damping device 120 may of course be arranged between one or more of the ladder tube sections 40a-k as described with reference to FIG. 1a in order to cause a damping effect for each of the ladder tube sections 40a-k. The lowermost ladder tube section 40k is possibly arranged without a damping device 120. In preferable embodiments, a respective damping device 120 is arranged on each one of the plurality of ladder tube sections 40a-k for achieving a damping effect on all of the ladder tube sections 40a-k.

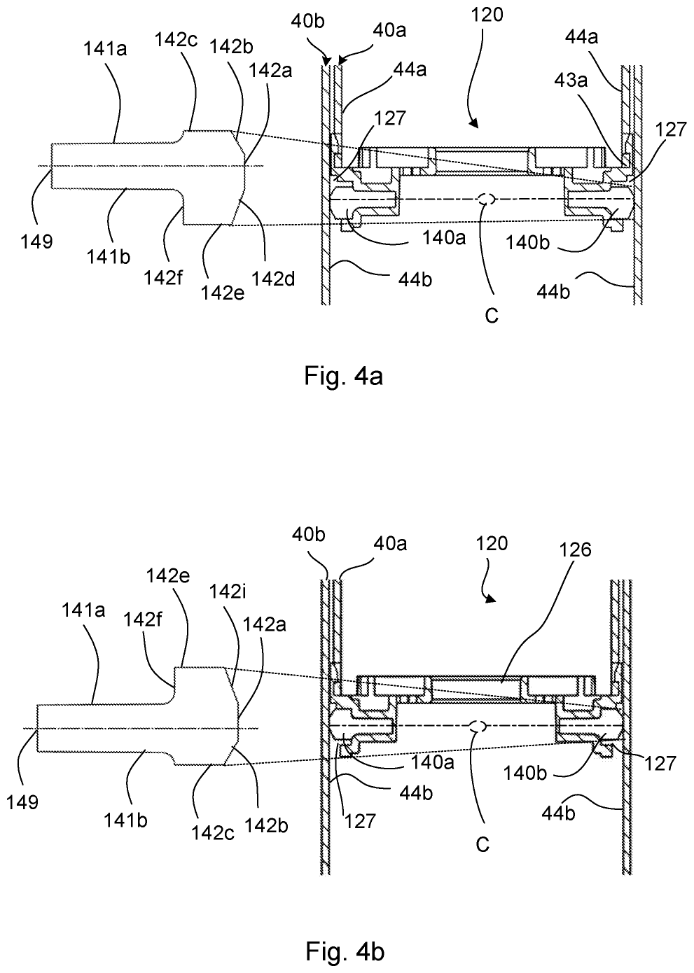

As best illustrated in FIGS. 4a-b, the inner ladder tube section 40a has a body that extends as an elongated portion and an inner side wall 44a, a top end portion (not shown) and a lower end portion 43a. The top end portion is arranged opposite the lower end portion 43a. In one embodiment, the damping device 120 is adapted to be mounted to the lower end portion 43a.

Similar to the inner ladder tube section 40a, the outer ladder tube section 40b has a body extending as an elongate portion. As discussed above, the diameter of the body is slightly larger than the diameter of the main body. The outer ladder tube section 40b has an inner side wall 44b. Once the ladder tube sections 40a, 40b are arranged in a ladder, the inner side wall 44b of the outer ladder tube section 40b is slidably arranged on the outside of the inner ladder tube section 40a such that it partly encloses the inner ladder tube section 40a.

In some embodiments, the inner ladder tube section 40a is arranged with at least one receiving means 42a. The receiving means 42a may be in the shape of an enclosed opening. In one embodiment the receiving means 42a is a hole configured to receive a fastening means to further fasten the damping device 140. Preferably, the receiving means is arranged near one of the ends of the inner ladder tube section 40a. The ladder tube section 40a may have two receiving means.

As best seen in FIGS. 3a-h, the damping device 120 comprises at least one mounting means 122 adapted to receive an asymmetric damping block 140. The mounting means 122 may comprise a cavity 123. The asymmetric damping block 140 is adapted to be arranged in the mounting means such that at least one surface 142a-b thereof slidably abuts about a circumferential position of the inner side wall 44b of the outer ladder tube section 40b. The terms “abut”, “contact”, and “engage” are used interchangeably herein in this setting.

The position of the one or more mounting means 122 depend on the cross-sectional shape of the ladder tubes 10, 12. In a triangular-shaped cross-section, as shown in FIG. 3a, where two mounting means 122 are present, it is beneficial if the mounting means 122 are arranged at two of the edges of the triangle. In a preferred embodiment the two mounting means 122 are arranged such that they are spaced apart from each other. In this way, sufficient damping is achieved on the ladder tube sections 40a-b.

The mounting means 122 may comprise a slot facing the inner side wall 44b of the outer ladder tube section 40b. The slot may face the inner side wall 44b about any circumferential position. The slot comprises a cavity, wherein the asymmetric damping block 140 is adapted to fit within the cavity. A different way of describing the cavities is that they are arranged in or form part of the mounting means 122,

The mounting means 122 may comprise two or more slots or cavities 123 facing different circumferential positions about the inner side wall 44b of the outer ladder tube section 40b. Each slot 123 may be adapted to receive an asymmetric damping block 140. Alternatively, two or more separate asymmetric damping blocks 140 may be fitted into a single slot. Additional asymmetric damping blocks 140 typically generate a higher frictional force on the ladder tube sections 40a-b. The damping effect can thus be tailored for different types of ladders by adapting the number of asymmetric damping blocks 140a-b and slots in the damping device 120. The embodiment of FIG. 3a-b illustrates two slots or cavities 123a-b.

The asymmetric damping block 140 may be adapted to fit within the cavity by means of clamping. Fitting the asymmetric damping block 140 within the cavity may be easily automated during the manufacture of the ladder 1 and/or damping device 120. Moreover, such a solution makes the damping device 120 installable in a plurality of different types of ladder tube modules since it is not reliant on specific screws and corresponding apertures, or other similar fixed structures.

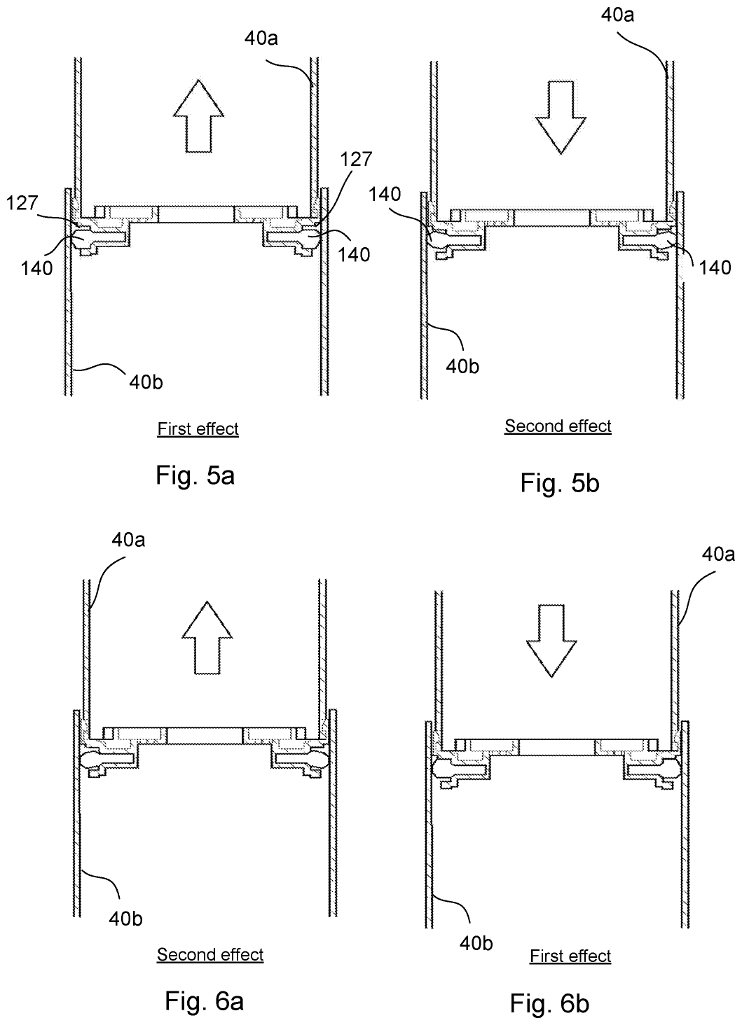

Depending on how the asymmetric damping block 140 is arranged in the mounting means 122, different damping behaviours can be achieved. This is particularly useful because it allows for adjustment of the damping behaviour depending on what type of ladder 1 is used and for what purpose. In some embodiments, the asymmetric damping block 140 may be movably arranged in the mounting means 122 which allows for damping behaviour adjustments such that any situation wherein damping in a ladder 1 is desired can be achieved. As a general interpretation, a damping behaviour corresponds to how the asymmetric damping block 140 acts upon contacting the inner side wall 44b during an outwards extension or inwards retraction, respectively, of the inner ladder tube section 40a with respect to the outer ladder tube section 40b. Alternatively put, the damping behaviour of the asymmetric damping block 140 correspond to a particular frictional force as generated upon slidable contact between at least two surfaces occurring, in this regard at least one surface 142a-b of the asymmetric damping block 140 and the inner side wall 44b of the outer ladder tube section 40b. The particular frictional force may be predetermined based on the defined shape of the asymmetric damping block 140. The damping behaviours will be described further with reference to FIGS. 5a-b and 6a-b.

One embodiment of a damping block is shown in FIG. 3c. The main body 141 of the asymmetric damping block 140 comprises at least two damping surfaces 142a-b. The two damping surfaces 142a-b may face different directions from each other. The damping surfaces 142a-b preferably each comprises at least two surface portions 144a, 144b. In the embodiment shown in FIG. 3c, the first damping surface 142a comprises four surface portions 144a and the second damping surface 142b comprises four surface portions 144b. As will be understood, different number of surface portions are possible and within the scope of this invention. The surface portions 144a, 144b may be arranged at different height from each other.

The damping device 140 has benefits as it provides the alternative to create an optional damping direction with the same device. This saves costs relating to the manufacturing process and warehouse handling as there is no need to have two kinds of manufacturing tools or storage of two different kinds of components.

The asymmetric damping block 140 comprises a first bending portion 148 which connects the at least two damping surfaces 142a-b. The first bending portion 148 may be arranged towards the inner wall 44b of the outer ladder tube section 40b once the asymmetric damping block 140 is arranged in the damping device 120 and the damping device 120 is arranged in the inner ladder tube section 40a.

The main body 141 further comprises a top surface 141a and a bottom surface 141b. The bottom surface 141b is arranged on opposite side of the top surface 141. Note that once the damping block is turned, the top surface may be facing the ground and the bottom surface may be facing the ground. The top and bottom surfaces should thus be seen as a first and second surface arranged opposite each other.

The main body 141 further comprises an end portion 149. The end portion 149 is arranged opposite the bending portion 148. The end portion 149 is arranged opposite the damping surfaces 142a-b. The end portion 149 is arranged to be placed into the mounting means 122 of the damping device 120. This is illustrated in FIG. 3d.

Upon a surface 142a-b of the asymmetric damping block 140 slidably abutting the inner side wall 44b, a frictional force is generated between a surface of the asymmetric damping block 140 and the inner side wall 44b, thereby causing a damping effect for the ladder tube sections 40a-b. The asymmetric damping block 140 may be removably inserted into the mounting means 122 to achieve an adjustment of the damping effect using the same asymmetric damping block 140.

The asymmetric damping block 140 may consist of a flexible homogeneous material, for instance plastics and/or rubber compositions. The material may for example be as an elastomeric or polymeric material. The asymmetric damping block 140 may be a single integrated pre-molded block.

The pre-molded block does not rely on any fixing means such as screws, bolts, knobs, etc., and associated apertures, to be able to be arranged in the cavity 123. The manufacturing procedure of the asymmetric damping block 140 and thus the damping device 120 is therefore simplified. Moreover, the asymmetric damping block 140 is a forgiving damping solution because it is not reliant on specific dimensions for the ladder tube sections 40a-b.

Turning back to FIGS. 3a-b, further parts of the damping device 120 will be described.

The damping device comprises a main body 121. The main body 121 preferably has a shape corresponding to the cross-sectional shape of the ladder tube section 40a to which it is to be arranged. The damping device 120 may further comprise an inclined or chamfered surface 130. The inclined or chamfered surface 130 has an extension in a direction that is the same as the arrangement of cavities 123. In other words, the inclined or chamfered surface 130 has an extension in a direction facing the outer ladder tube 40b.

Upon the ladder section 40a reaching the locking pin, the inclined or chamfered surface 130 of the damping device 220 will interact with the locking pin so that the locking pin is pushed. This enables the ladder section to pass the locking pin. It also inactivates the locking of the lower ladder section, which is held by the retaining mechanism and the locking pin, since only a chamfered end of the locking pin is maintaining the bar section in position and the weight of the ladder section will push the locking pin further away from the tube sections.

The damping device 120 may further comprise an engagement surface 125 that is configured to engage with the inner ladder tube 40a. In the embodiment shown, the damping device 140 comprises two engagement surfaces 125 125. The engagement surfaces 125125 are arranged above a respective cavity 123a, 123b. The engagement surface 125 has an extension in a direction that is opposite of the arrangement of cavities 123 compared to the main body 121. The engagement surface 125 is arranged in an opposite direction as the inclined or chamfered surface 130, if present. In other words, the engagement surface 125 has an extension in a direction facing the inner ladder tube 40a.

The engagement surface 125 is arranged with an engagement means 128. The engagement means 128 may be a protrusion of any kind adapted to engage into the opening or receiving means 42a of the inner ladder tube section 40a. The engagement surface 125 is, once arranged on the inner ladder tube section 40a, arranged on the outer side of the inner ladder tube 40a. This is illustrated in FIGS. 3d-e.

The damping device 120 may further comprise an attachment protrusion 129. The attachment protrusion 129 could for example be a pig or other similar structure that protrudes from the main body 121. The attachment protrusion 129 is configured to help fixate the damping device 120 into the inner ladder tube 40a. The attachment protrusion 129 is clamped on the inner side of the inner ladder tube 40a.

The damping device 120 preferably comprises one or more protruding parts 124a-i. The protruding parts 124 forms part of a top portion of the damping device 120 by extending out from the main body 121. The protruding parts 124a-i are preferably arranged to form contact with the inner tube 40a. The protruding parts 124a-i are arranged to be clamped inside the inner surface of the inner tube 40a. In the embodiment shown in FIG. 3b, a plurality of protruding parts 124a-i are arranged on the damping device 120. The number of protruding parts 124a-i may vary, and may for example be nine. If the ladder tube is of a rectangular shape, as shown in FIG. 3a-h, the damping device 120 may have three protrusions on each side, thus adding up to nine protrusions. However, as should be understood other numbers and configurations of the protrusions are possible.

In one embodiment the protruding parts 122 are arranged on an elevated support structure 121a arranged on the body 121. If present, the elevated support structure 121a is not in direct contact with the inner ladder tube 40a. However, as stated above, if the support structure 121a is arranged with protruding parts 122, these will be in contact with the inner ladder tube 40a.

The damping device 120 may further comprise a guiding means. The guiding means may be arranged to guide the inner ladder tube 40a and its damping device 120 into the outer ladder tube 40b. The guiding means may be a protruding portion. The guiding means could be a flap. If the damping device 120 comprises two mounting means 122a-b, the guiding means is preferably arranged between the two mounting means 122a-b. The length of the guiding means is preferably the same as the length of the guiding means.

The main body 121 of the damping device 120 may further comprise a through going hole 126. The through going hole 126 is preferably arranged in the center of the body. In a preferred embodiment the through going hole 126 is arranged with a protrusion extending along the circumference of the hole 126. The hole 126 may be used during manufacturing and/or during mounting of the damping device 120.

The figures FIGS. 3a, 3d, 3e and 3g further illustrates a method of arranging the damping device 120 into a ladder. In 3a, an inner ladder tube section 40a and a damping device 120 is provided. The damping device 120 comprises mounting means 122a-b adapted to receive a damping block 140. The mounting means 122a-b has as least one cavity 123a-b. In the embodiment shown in FIGS. 3a-g, the damping device 120 comprises two mounting means 122a-b, each mounting means 122a-b comprises a cavity 123a-b. Each cavity is arranged to at least partly enclose a respective asymmetric damping device 140a-b.

Once the damping device 120 is pushed into the inner ladder tube 40a, the engagement surfaces 125, and its respective engagement means 128, will engage with the receiving means 42a of the inner ladder tube section 40a. Moreover, the attachment protrusion 129 is further fixating the damping device in the inner ladder tube 40a. Additionally, the protruding parts 124a-i will contact the inner surface 44a of the inner ladder tube 40a.

In FIG. 3d, two asymmetric damping blocks 140a-b are provided. The asymmetric damping blocks 140a-b are adapted to be arranged in the cavities 123a-b, for instance by means of clamping. The asymmetric damping blocks 140a-b may advantageously be arranged at various positions in the cavities, having various orientations and various sizes. This will soon be described further with reference to FIGS. 4-5.

FIGS. 3e and 3f show the two asymmetric damping blocks 140a-b being arranged in the cavities 123a-b of the damping device 120, which in turn is arranged in in or at the inner ladder tube section 40a. As illustrated in the figures, at least one surface 142a-b of the asymmetric damping blocks 140a-b are at least partly protruding from the cavities of the damping device 120. These surfaces are to be slidably abutting the outer ladder tube section 40b to enable a damping behaviour in the corresponding step.

In FIGS. 3g and 3h, the inner ladder tube section 40a is slidably inserted into the outer ladder tube section 40b.

The asymmetric damping block 140 can be placed in at least two different orientations in the cavities 123a, 123b of the mounting means 122a-b. The different orientation of the damping block causes different damping behaviors.

FIGS. 4a-b, illustrates two different orientations of the damping block 140. In FIG. 4a, the damping block 140 is arranged in a first orientation and in FIG. 4b the damping block 140 is arranged in a second orientation. The second orientation may correspond to rotation of approximately 180 of the damping block compared to the first orientation.

The damping block 140a-b comprises a plurality of surfaces 142a-i. At least one surface thereof, in this case 142a, is slidably abutting about two different circumferential positions of the inner side wall 44b of the outer ladder tube section 40b.

The asymmetric damping blocks 140a-b are asymmetric with respect to a center axis extending horizontally from a center point C, from the inside towards the outside of the ladder tube sections 40a-b. In some embodiments, the asymmetric damping block 140a-b may be asymmetric with respect to a vertically extending center axis.

In some embodiments, the damping behaviour is determined upon the manufacturing of the ladder 1 and/or the damping device 120. By inserting the asymmetric damping block 140 having a certain size, orientation and at a certain position, the desired damping behaviour is obtained. The different damping behaviours for the inner ladder tube section 40a may in different embodiments depend on orientation, position and/or size of the asymmetric damping blocks 140a-b arranged in the cavities 123a-b.

The damping behavior and damping effects caused by the damping block 140 will now be described with reference to FIGS. 4-6. In summary, the damping block 140 can be placed in at least two different orientations, as shown in FIGS. 4a-b. The different orientations causes at least two damping behaviours, as shown in FIGS. 5 and 6, respectively. Each damping behavior has at least two effects, as shown in FIG. 5a-b for the first damping behaviour and as shown in FIG. 6a-b for the second damping behaviour. The effect may be to either to provide damping or not providing damping to the ladder tubes.

In FIG. 4a, a first orientation of the asymmetric damping blocks 140a-b causes a first damping behaviour for the ladder tube sections 40a-b. This behaviour may correspond to the behaviour illustrated in FIGS. 5a-b. In FIG. 4b, a second orientation of the asymmetric damping blocks 140a-b causes a second damping behaviour for the ladder tube sections 40a-b. This behaviour may correspond to the behaviour illustrated in FIGS. 6a-b.

As indicated by the illustrations of FIG. 4a-b, at least the surfaces 142a are in both cases slidably abutting the inner wall 44b. When the damping device 120 is arranged in the orientation as shown in FIG. 4a, a space 127 is formed between the outer ladder tube section 40b and the damping block 140. Once the damping block is forced to move, it will move into the space 127. The movement, or rotation, will cause a damping effect on the ladder tubes. When the damping block 140 is arranged still, no damping force is created on the ladder tubes. FIGS. 5a-b illustrate a first damping behaviour and FIGS. 6a-b a second damping behavior. The arrows in the figures indicate an ongoing movement of the ladder tube sections 40a-b with respect to one another. The upwards directed arrow corresponds to an outwards extension of the inner ladder tube section 40a with respect to the outer ladder tube section 40b. The downwards directed arrow corresponds to an inwards retraction (or collapsing) of the inner ladder tube section 40a with respect to the outer ladder tube section 40b.

The asymmetric damping blocks 140 arranged in the mounting means 122 causes a predictable damping behaviour at a given situation. Each damping behaviour comprises a first and second effect, respectively. The effects are caused by the interaction of the damping block and the relative movements of the ladder tube sections 40a-b, i.e. extension or retraction. The first and second effects are typically opposite effects, such as damping and no damping, as soon will be described further.

FIG. 5a-b show the damping block in a first orientation (or position). FIG. 5a illustrates an outwards extension of the inner ladder tube section 40a with respect to the outer ladder tube section 40b. The outwards extension of the inner ladder tube section 40a with respect to the outer ladder tube section 40b releases the damping effect caused by the asymmetric damping block 140. In other words, the damping effect caused by the asymmetric damping block 140 is released. This is referenced to as the first effect.

In FIG. 5b, inwards retraction of the inner ladder tube section 40a with respect to the outer ladder tube section 40b forces the asymmetric damping block 140 into contact with the inner side wall of the outer ladder tube section 40b. The asymmetric damping block 140 is thus increasingly moves such that the frictional force generated by the asymmetric damping block 140 is increased. The movement may optionally be accompanied with a slight deformation of the damping block 140. This is referenced to as the second effect.

FIG. 6a-b show the damping block in a second orientation (or position). FIG. 6a illustrates an outwards extension of the inner ladder tube section 40a with respect to the outer ladder tube section 40b. The outwards extension of the inner ladder tube section 40a with respect to the outer ladder tube section 40b forces the asymmetric damping block 140 to move, causing a damping effect on the ladder tube sections 40a-b. This is referenced to as the second effect.

FIG. 6b illustrates an inwards retraction of the inner ladder tube section 40a with respect to the outer ladder tube section 40b. The inwards retraction of the inner ladder tube section 40a with respect to the outer ladder tube section 40b releases the damping effect caused by the asymmetric damping block 140. This is referenced to as the first effect.

As should be noted by a skilled reader, depending on how the asymmetric damping blocks 140a-b are arranged in the cavities 123, different damping behaviours may be exhibited for the same movements of the ladder tube sections 40a-b.

As previously been described, the asymmetric damping blocks 140a-b may cause a plurality of different damping behaviour depending on their respective orientations. For instance, each 45° may correspond to a particular damping behaviour, i.e. 45°, 90°, 135° and 180°. Other behaviours may be realized for asymmetric damping blocks 140a-b having other asymmetric properties.

In one or more embodiments, the size of the asymmetric damping block 140 arranged in the mounting means 122 causes the damping behaviour. The size of the asymmetric damping block 140 will cause a larger or smaller portion thereof to contact the outer ladder tube section 40a-b, thereby increasing or decreasing the generated frictional force. Size adjustments of the asymmetric damping block 140 may be accomplished by providing an asymmetric damping block 140 comprising a flexible homogeneous material, such as the ones previously described. The asymmetric damping block 140 may alternatively consist entirely of the flexible homogeneous material. The flexible material may flex when forces are applied so that the dimensions are temporarily decreased in order to arrange the asymmetric damping block 140 in the mounting means 122. In other embodiments, the damping device 120 could use a spring-based system that allows the dimensions to be temporarily decreased. Alternatively, the flexible material may be temperature-sensitive such that the prevailing temperature, or possibly humidity, temporarily decreases or increases the size of the asymmetric damping block 140.

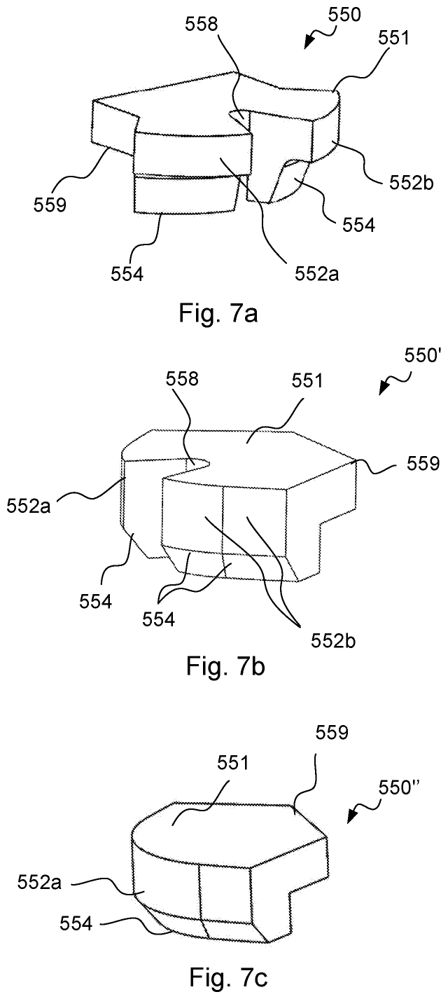

In addition to the damping block 140 as been discussed with reference to FIGS. 3-6, other embodiments are possible. FIGS. 7a-c shows the additional embodiments 550; 550′; 550″. The asymmetric damping blocks 550; 550′; 550″ in FIGS. 7a-c each comprises a main body 551. The main body 551 of the asymmetric damping blocks 550; 550′ comprises at least two first damping surfaces 552a-b. The two first damping surfaces 552a-b may face different directions from each other. The asymmetric damping blocks 550; 550′; 550″ may further comprise at least one secondary damping surfaces 554. Each secondary damping surfaces 554 is arranged below its respective first damping surfaces 552a-b. The first damping surfaces 552a-b extend further away from the main body 551 than the secondary damping surfaces 554a-b.

The asymmetric damping blocks 550; 550′ comprise a first bending portion 558 which connects the at least two first damping surfaces 552a-b. The first bending portion 558 may be arranged towards the inner wall 44b of the outer ladder tube section 40b once the asymmetric damping blocks 550; 550′ are arranged in the damping device 120 and the damping device 120 is arranged in the inner ladder tube section 40a.

The embodiment shown in FIG. 7b is similar to that of FIG. 7a and differs mainly in that it comprises more damping surfaces. The asymmetric damping block 550′ comprises four first damping surfaces 552a-b and four secondary damping surfaces 554, two arranged at each side of the first bending portion 558.

The embodiment shown in FIG. 7c shows an asymmetric damping block 550″ comprising one first damping surface 552a. The asymmetric damping block 550″ may further comprise one secondary damping surface 554. In this embodiment, the asymmetric damping block 550″ does not have any bending portions 558.

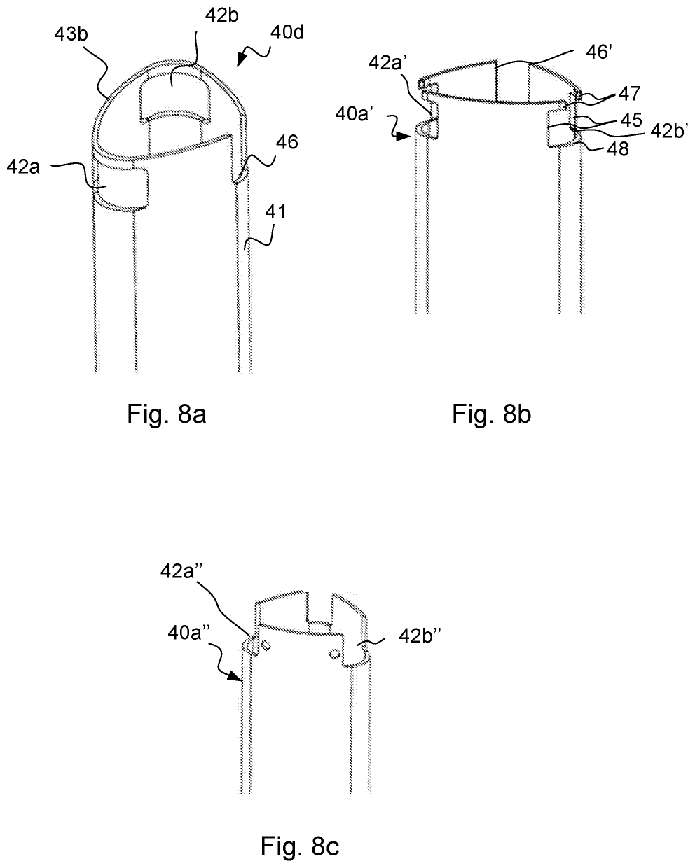

The asymmetric damping blocks 550, 550′, 550″″ shown in FIGS. 7a-c could be used with the damping device 120 as has been defined, as well as any of the damping devices 120; 220; 320; 420 which will s be described with reference to FIGS. 8-12.

Before turning to further embodiments of the damping device, two further embodiments of an inner ladder tube section 40a will be described with reference to FIGS. 8a-c. In some embodiments the inner ladder tube section 40a comprises receiving means 42 are arranged to receive the damping device 120. In one embodiment, as shown in FIG. 8a, the inner ladder tube section 40a comprises two receiving means 42a, 42b, where both are in the shape of an enclosed opening. The openings of the receiving means 42a, 42b have dimensions that are slightly bigger than the corresponding mounting means 122a, 122b of the damping device 120. In the embodiment shown in FIG. 8a, the receiving means 42a, 42b are of a rectangular shape. However, the receiving means 42a, 42b may have other shapes depending on the shape of the damping device 120 and the cross-sectional shape of the ladder tube sections 40a-b.

As shown in FIG. 8b, the inner ladder tube section 40a′ may have receiving means 42a′-b′ that form non-enclosed openings such as recesses. Yet a further embodiment is shown in FIG. 8c.

Preferably, the receiving means 42a-b are arranged near one of the ends of the inner ladder tube section 40a. In the embodiments where the receiving means 122a-b are enclosed openings, the distance between the top of the opening and one of the end portions 43a-b of the inner ladder tube section 40a is approximately 0.5 to 6 mm, preferably 1 to 4 mm and even more preferably 2-3 mm. However, as will be described in other embodiments, the receiving means 42a-b could be non-enclosed openings, such as a recesses.

The positions of the two receiving means 42a-b depend on the cross-sectional shape of the ladder tubes 10, 12. In a triangular-shaped cross-section, as shown in FIG. 8a, it is beneficial if the two receiving means 42a-b are arranged at two of the edges of the triangle. In a preferred embodiment the two receiving means 42a-b are arranged such that they are spaced apart from each other. In this way, sufficient damping is achieved on the ladder tube sections 40a-b.

The inner ladder tube section 40a may further comprise a recess 46 for receiving an inclined or chamfered surface. The recess 46 is preferably arranged in between the two receiving means 42a-b.

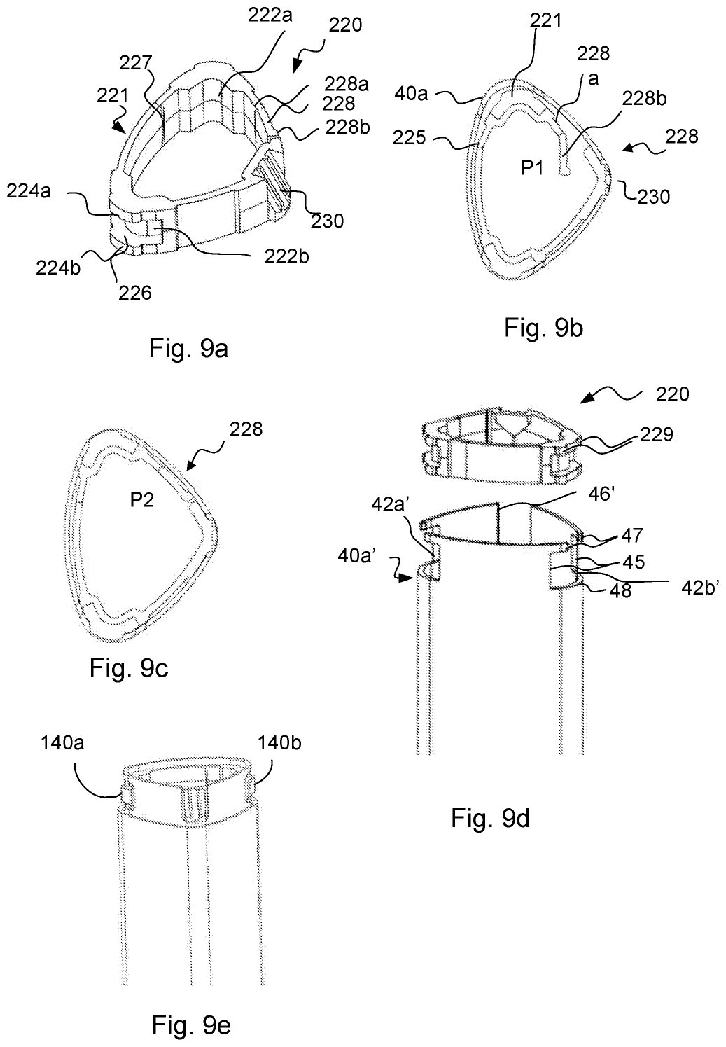

Different embodiments of a damping device will now be described with reference to FIGS. 9-11.

In one or more embodiments, a portion of the damping device is arranged above one edge of the inner ladder tube section such that it extends beyond the inner side wall. In one or more embodiments, the damping device is arranged such that its dimensions can be temporarily decreased for fitting into the inner ladder tube section. In one or more embodiments, the damping device comprises a flexible material. In one or more embodiments, the damping device comprises a spring-based mechanism that allows the dimensions to be altered when force is applied. In one or more embodiments, the damping device comprises at least one pivot point to allow a temporarily change of the dimension or size of the damping device. In one or more embodiments, the at least one pivot point is a movable arm allowing the damping device to be press-fitted or clamped into the inner ladder tube section. In one or more embodiments, the receiving means are enclosed openings, partly enclosed openings, or recesses. In one or more embodiments, the damping device comprises a plurality of protruding portions for attachment to the receiving means.

FIGS. 9a-d show an embodiment of damping device 220. The damping device 220 comprises a main attachment body 221 that has a shape corresponding to the cross-sectional shape of the ladder tube section 40a to which it is to be arranged. The damping device 220 may be constructed by any kind of suitable plastic material.

As seen in FIG. 9a, the damping device 220 comprises two mounting means 122a, 122b (122a being obscured due to the isometric view only showing one side). Once the damping device 220 is arranged in the inner ladder tube section 40a, the two mounting means 122a, 122b are arranged in conjunction with the receiving means 42a, 42b of the inner ladder tube section 40d. The number of mounting means 222 typically corresponds to the number of receiving means 42 of the ladder tube section.

The mounting means 222a-b may comprise an indentation or a recess in the main body 221 arranged to receive a respective asymmetric damping block, as has been described herein. In some embodiments, the mounting means 222a-b may comprises a through hole instead of an indentation or recess.

The mounting means 222a-b may be arranged with a top protrusion 224a and a lower protrusion 224b. These are arranged on opposite side of an opening of the mounting means 222a-b in a direction of the ladder tube extension/retraction. The protrusions 224a-b may assist in keeping the damping device 220 in position in the ladder tube section 40a.

The lower protrusion 224a and the top protrusion 224b form together with the main body 221 respective protruding surfaces 226. The protruding surfaces 226 and the mounting means 222a, 222b are configured to receive a respective asymmetric damping block (not shown).

FIG. 9b is a top view of the embodiment shown in FIG. 9a. The main body comprises a movable arm 228 having a first portion 228a and a second portion 228b. The first portion 228a of the arm 228 is connected to the main body 221, preferably by a pivot point (not shown). The first portion 228a is thus arranged as a pivot point, around which the arm 228 is pivoted. The second portion 228b is pivotable between a first position P1, shown in FIG. 9b, and a second position P2, shown in FIG. 9c. The pivot point helps to reduce the diameter of the main body 221 when the arm 2128 is arranged in the first position P1.

In the first position P1, the arm 228 is pivoted towards the inside of the damping device 220. This position of the arm 228 allows the damping device 220 to be smaller in dimension so that it can be moved inside a ladder tube section 40a-k in order to place it in its correct position. This position is thus only used during mounting and dismounting of the damping device 220.

In the second position P2, the arm 228 is pivoted outwards towards the inner ladder tube section 40a to which it is arranged. In this position, the damping device 220 is locked into the inner ladder tube section 40a by clamping. When the arm 228 is moved into the second position P2, the dimension of the damping device 220 is such that it is clamped towards the inner wall of the inner ladder tube section 40a, i.e. the width of the damping device 220 is just slightly smaller than the width of the inner ladder tube section 40a.

The main body 221 is arranged with at least one pivot point 225. In the embodiment shown in FIGS. 9a-d, the main body 221 is arranged with two pivot points; a central pivot point 225 and the pivot point between the two arm portions 228a-b. The central pivot point 225 helps to further reduce the diameter of the main body 221 when the arm 228 is arranged in the first position P1.

Although the above have been described using a pivoting arm 228, it should be noted that the damping device 220 could have other types of features that allows the device to be reduced in size. The damping device 220 could for example comprise a flexible material, that flexes when forces is applied so that the dimensions are temporarily decreased in order to attach the damping device 220 in a ladder tube section 40a-k. In other embodiments, the damping device 220 could use a spring-based system that allows the dimension to temporarily be decreased.

Once again referring to FIGS. 9a-d, the main body 221 may further comprise one or more inner recesses 227 for connecting the different portions of the main body 221.

As further seen in FIGS. 9a-b, the damping device 220 may be arranged with an inclined or chamfered surface 230. Upon the ladder section 40a reaching the locking pin, the inclined or chamfered surface 230 of the damping device 220 will interact with the locking pin so that the locking pin is pushed. This enables the ladder section to pass the locking pin. It also inactivates the locking of the lower ladder section, which is held by the retaining mechanism and the locking pin, since only a chamfered end of the locking pin is maintaining the bar section in position and the weight of the ladder section will push the locking pin further away from the tube sections.

The damping device 2120 may be arranged inside an inner ladder tube section 40a. As shown in FIG. 9e, the damping device 220 comprises two mounting means 2122a-b which have received a respective asymmetric damping blocks 140a-b. In FIG. 9e, the two asymmetric damping blocks 40a-b are arranged in their respective damping positions and the inner ladder tube section 40a is thus ready to receive the outer ladder tube section (not shown). The asymmetric damping blocks 140a-b are attached to the damping device 220 once the damping device 220 is arranged in its inner ladder tube section 40a. As described above, the attachment may be made by means of clamping. No screws or other fixed fastening mechanisms are therefore needed. As can be seen in FIG. 9e, the damping device 120 is mounted on the inner side of the inner ladder tube section 40a. The damping device 120 is locked axially with the inner ladder tube section 40a. The asymmetric damping blocks 140a-b are mounted from the outside into the mounting means 222a-b. The mounting means 222a-b may, for instance, be slots in the main body 221 of the damping device having respective cavities. The asymmetric damping blocks 140a-b are fixated both axially and radially in the mounting means 222a-b. In one embodiment, the asymmetric damping blocks 140a-b are mounted into the mounting means 222a-b, which may be a through hole in the main body 121. The above section relating to the placement of the damping blocks are true for all embodiments of the damping deice 120, 220, 320, 420 disclosed herein.

The damping device 220 may further comprises a plurality of locking shoulders 229 arranged on the top and lower protrusions. This is shown in FIG. 9d. The locking shoulders 229 help to fasten the damping device 220 to the inner ladder tube section 40a′. This embodiment of the damping device 220 is especially beneficial when the inner ladder tube section 40a′ has receiving means 42a′-b′ that form non-enclosed openings such as recesses. Each recess is formed by a lower end 48 and two sides 45 arranged opposite each other. Opposite the lower end 48 are two extending elements 47 arranged, the two extending elements 47 partly enclosing the recess. The locking shoulders 229 of the damping device 220 is arranged to connect with the two extending elements 47.

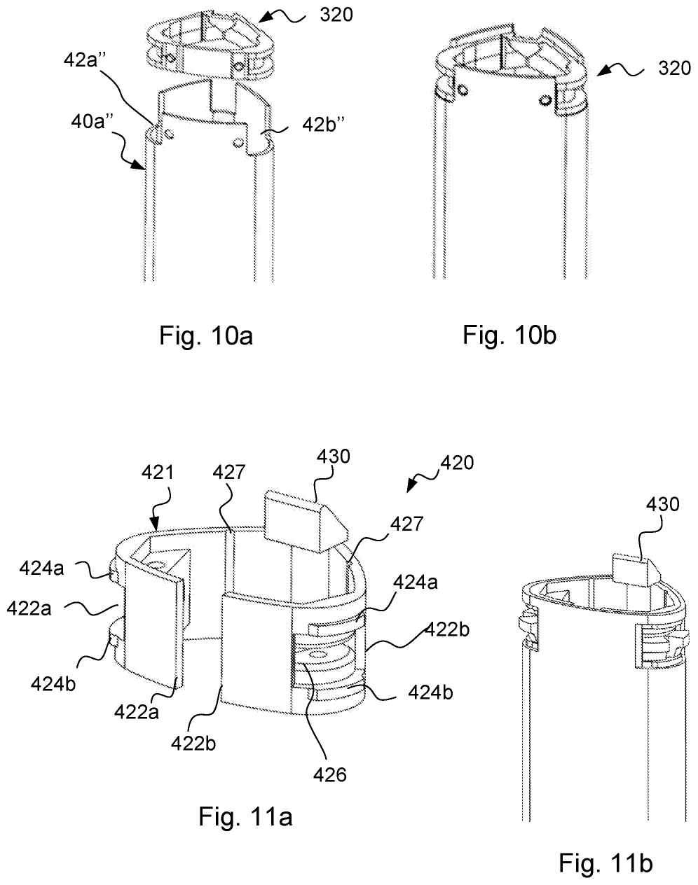

FIGS. 10a-b illustrate a third embodiment of a damping device 320. The damping device 320 is preferably arranged in the inner ladder tube section 40a″ shown in FIG. 8c. The third embodiment of the damping device 320 is similar to the second embodiment of the damping device 220 with the differences that the main body lacks the movable arm. Instead, the damping device 320 is connected to the inner ladder tube section 40a″ by screws, nail or another member that is not attached in the receiving means 42a″-b″ (here in the form of a recess forming a non-enclosed opening).

FIGS. 11a-b illustrate yet one embodiment of a damping device 420. This damping device 420 could for example be arranged in an inner ladder tube section 40a, as seen in FIG. 8a. The damping device 420 comprises a main body 421 that has a shape corresponding to the cross-sectional shape of the ladder tube section 40a to which it is to be arranged. The damping device 420 comprises two mounting means 422a-b. The mounting means 422a-b are arranged with a top protrusion 424a and a lower protrusion 424b. These are arranged on opposite side of each opening of the mounting means 422a-b in a direction of the ladder tube extension. These protrusions 424a-b may assist in keeping the damping device 420 in position in the ladder tube section 40a. The protrusions 424a-b together with the main body 421 form respective protruding surfaces 426. The protruding surfaces 426 and the mounting means 422a-b are configured to receive the respective asymmetric damping block 140a-b. The main body 421 has a first vertical end 422a and a second vertical end 422b. The main body 421 is preferably arranged in an at least partly flexible material, thus allowing the damping device 420 to be fitted into the ladder tube section 40a.

The damping device 420 may be arranged with an inclined or chamfered surface 430, which has the same function as was described in conjunction with FIGS. 9a-e. In this embodiment the inclined surface 430 is arranged on the top surface of the main body 421 of the damping device 420 such that it extends above the top end of the damping device 420 and extends above the end of the inner ladder tube section 40a to which the damping device 120 is attached.

Since the damping device 420 shown in FIG. 11a has an inclined surface 430 arranged on the top surface of the damping device 420, there is no need for a recess in the ladder tube section 40a.

FIG. 11b shows a situation where the damping device 420 has an inclined surface 430 extending above the top of the damping device 420.

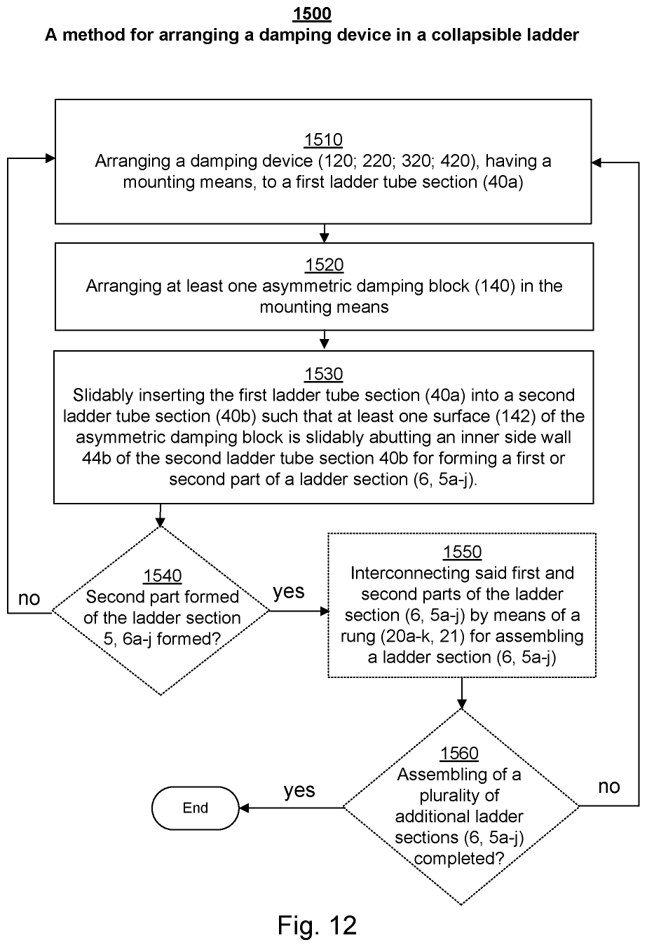

FIG. 12 illustrates a schematic flowchart diagram of a method 1500 for arranging a damping device in a collapsible ladder 1 according to one embodiment. In this method 1500, one ladder section 5a-j, 6 is arranged at a time, and each subsequent ladder section 5a-j, 6 is arranged below the previous ladder section 5a-j, 6. The method 1500 may additionally involve one or more of the embodiments as has been described throughout this disclosure.

The method 1500 comprises a first step of arranging 1510 a damping device 120; 220; 320; 420 to a first ladder tube section 40a, the damping device 120 comprising at least one mounting means 122.

The method 1500 comprises a next step of arranging 1520 at least one asymmetric damping block 140 in mounting means 122.

The method 1500 comprises a next step of slidably inserting the first ladder tube section 40a into a second ladder tube section 40b such that at least one surface 142 of the asymmetric damping block is slidably abutting an inner side wall 44b of the second ladder tube section 40b. A first part of a ladder section 6, 5a-j is thus formed.

The method steps 1510, 1520, and 1530 are subsequently repeated such that a second part of the ladder section 6, 5a-j is formed.

Upon the first and second parts of the ladder section 6, 5a-j being formed, these are interconnected at 1550 by means of a rung 20a-k, 21 for assembling the ladder section 6, 5a-j.

All of the steps 1510, 1520, 1530, 1540, and 1550 are then repeated 1560 until a plurality of additional ladder sections 6, 5a-j have been assembled, as defined by the size of the finished collapsible ladder 1. The difference is that each next damping device 120; 220; 320; 420 at step 1510 is instead arranged in the lowermost (i.e. second) ladder tube section 40b instead of the first ladder tube section 40a.

In alternative arranging methods, the entire ladder tubes 10, 12 are arranged individually, one by one, and are then interconnected by means of the rungs 20a-k, 21. The skilled persons may realize alternative manufacturing procedures wherein the damping device 120; 220; 320; 420 is arranged according to the subject matter as disclosed herein.

Further alternative aspects of the present disclosure will now be summarized. A damping device for a telescopic ladder comprising an inner ladder tube section and an outer ladder tube section is provided, where the inner ladder tube section is slidably arranged with the inner outer tube section, and wherein the damping device comprises an attachment member having at least one mounting means, wherein the at least one mounting means is configured to receive a respective damping block.

A damping device for a telescopic ladder is provided. The damping device comprising an inner ladder tube section and an outer ladder tube section, having an inner side wall, where the inner ladder tube section is slidably arranged with the inner outer tube section, and where the inner ladder tube section is arranged with at least one receiving means, and wherein the damping device comprises an attachment member having at least one mounting means, and wherein the at least one mounting means is configured to be arranged in the at least one receiving means of the inner ladder tube, wherein the at least one mounting means is configured to receive a respective damping block having at least one damping surface.

A damping block is provided. The damping block is for a damping device for a telescopic ladder comprising an inner ladder tube section and an outer ladder tube section, where the inner ladder tube section is slidably arranged with the inner outer tube section, wherein the damping block is configured to damp the movement between the inner ladder tube section and the outer ladder tube section.

The damping block is asymmetric. The damping block can be turned upside down to change the damping effect. The damping surfaces of the damping blocks are arranged such that the damping surface abuts against the inner side wall of the outer ladder tube section when the ladder tube sections are slidably arranged.

The damping device may comprise two mounting means, each configured to receive one damping block. The inner ladder tube section may be arranged with two receiving means each configured to receive a respective mounting means of the damping device.

The damping device may be arranged at least partly on the inside of the ladder tube section. In one embodiment, the whole damping device is arranged inside the ladder tube section. In an alternative embodiment, a portion of the damping device is arranged above one of the edges of the ladder tube section, such that it extends beyond the inner wall of the ladder tube.

The damping device is preferably arranged such that its dimensions can be temporarily decreased so that it can be fitted into the ladder tube section. This may be achieved in many ways, for example using a flexible material for the damping device and/or using a spring-based mechanism that allows the dimensions to be altered when force is applied. Additionally or alternatively, the damping device may comprise at least one pivot point to allow a temporarily change of the dimension or size of the damping device. The pivot point may be in the form of a pivotable arm. The pivot point allows the damping device to be press-fitted or clamped into the inner ladder tube section.

The receiving means of the ladder tube may be enclosed openings, partly enclosed openings or recesses.

The mounting means of the damping device may comprise a recess in the main body.

The damping device may comprise a plurality of protruding portions for easier attachment to the receiving means.

The invention has mainly been described above with reference to a few embodiments. However, as is readily appreciated by a person skilled in the art, other embodiments than the ones disclosed above are equally possible within the scope of the invention, as defined by the appended patent claims.

1. A damping device for a collapsible ladder having an inner ladder tube section and an outer ladder tube section with an inner side wall, the inner ladder tube section being slidably arranged with the outer ladder tube section, the damping device comprising:
a main body having a top portion adapted to be arranged at least partly in the inner ladder tube section, and at least one mounting means; and
an asymmetric damping block adapted to be arranged in the at least one mounting means;
wherein the asymmetric damping block has at least one surface slidably abutting the inner side wall of the outer ladder tube section when arranged in the collapsible ladder.

2. The damping device according to claim 1, wherein the asymmetric damping block is asymmetric with respect to a center axis extending horizontally from a center point of the inside of the inner and the outer ladder tube sections towards the outside of the inner and the outer ladder tube sections.

3. The damping device according to claim 1, wherein the asymmetric damping block when arranged in the mounting means is arranged to cause one of at least two different damping behaviours for the inner and the outer ladder tube sections.

4. The damping device according to claim 3, wherein an orientation of the asymmetric damping block, relative the inner side wall, causes one of the at least two different damping behaviours.

5. The damping device according to claim 3, wherein a position of the asymmetric damping block when arranged in the receiving portion causes one of the at least two different damping behaviours.

6. The damping device according to claim 3, wherein each damping behaviour comprises a first effect and a second effect, wherein the first and the second effects are different from each other.

7. The damping device according to claim 3, wherein a first orientation or position of the asymmetric damping block causes a first damping behaviour for the inner and the outer ladder tube sections; and
wherein a second orientation or position of the asymmetric damping block causes a second damping behaviour for the inner and the outer ladder tube sections.

8. The damping device according to claim 7, wherein in the first damping behaviour,
inwards retraction of the inner ladder tube section with respect to the outer ladder tube section causes a second effect, wherein the second effect forces the asymmetric damping block to move causing a damping effect on the inner and the outer ladder tube sections, and
outwards extension of the inner ladder tube section with respect to the outer ladder tube section causes a first effect, wherein the first effect releases the damping effect caused by the asymmetric damping block.

9. The damping device according to claim 7, wherein in the second damping behaviour,
inwards retraction of the inner ladder tube section with respect to the outer ladder tube section causes a first effect, wherein the first effect releases a damping effect caused by the asymmetric damping block, and
outwards extension of the inner ladder tube section with respect to the outer ladder tube section causes a second effect, wherein the second effect forces the asymmetric damping block to move causing the damping effect on the inner and the outer ladder tube sections.

10. The damping device according to claim 1, wherein the at least one mounting means comprises a cavity facing the inner side wall; and
wherein the asymmetric damping block is adapted to at least party fit within the cavity.

11. The damping device according to claim 10, wherein the damping device comprises two mounting means each having a cavity and two damping blocks;
wherein the respective cavity is facing different circumferential positions about the inner side wall; and
wherein the asymmetric damping blocks each are adapted to fit at least partly within each respective cavity.

12. The damping device according to claim 10, wherein the asymmetric damping block is adapted to fit within the cavity via clamping.

13. The damping device according to claim 1, wherein the asymmetric damping block is a single integrated pre-molded block.

14. The damping device according to claim 1, wherein the asymmetric damping block consists of a flexible homogeneous material.

15. The damping device according to claim 1, wherein the damping device is arranged at least partly on the inside of the inner ladder tube section.

16. The damping device according to any claim 1, wherein a portion of the damping device is arranged on the outside of the inner ladder tube section to further fixate the damping device to the inner ladder tube section.

17. A collapsible ladder comprising:
a plurality of ladder sections, each ladder section having two ladder tubes arranged parallel to each other and interconnected by a rung to form the respective ladder section;
wherein each ladder tube is telescopically inserted into a ladder tube of a lower section to form the collapsible ladder;
wherein each ladder section includes a damping device according to claim 1.

18. A method for arranging a damping device in a collapsible ladder, the method comprising:
arranging a damping device to a first ladder tube section, the damping device having at least one mounting means;
arranging at least one asymmetric damping block in the at least one mounting means; and
slidably inserting the first ladder tube section into a second ladder tube section such that at least one surface of the asymmetric damping block is slidably abutting an inner side wall of the second ladder tube section for forming a first part of a ladder section.

19. An asymmetric damping block adapted to be arranged in a damping device for a collapsible ladder wherein the damping device comprises mounting means,
wherein the asymmetric damping block is adapted to be arranged in the mounting means.
